(19) United States
(12) Patent Application Publication
(10) Pub. No.: US 2014/0279320 A1
(43) Pub. Date: Sep. 18, 2014

(54) ALLOCATING AND PRICING VIRTUAL RESOURCES

(71) Applicant: BRACKET COMPUTING, INC., Sunnyvale, CA (US)

(72) Inventors: James A. Scheinblum, San Francisco, CA (US); Shalabh Mohan, Moutain View, CA (US); Jason A. Lango, Mountain View, CA (US); Thomas B. Gillis, Los Altos, CA (US); Robert K. Van Zant, Jr., San Mateo, CA (US)

(73) Assignee: BRACKET COMPUTING, INC., Sunnyvale, CA (US)

(21) Appl. No.: 13/835,167

(22) Filed: Mar. 15, 2013

(51) Int. Cl. G06Q 30/04

(52) U.S. Cl. CPC G06Q 30/04
USPC 705/34

(57) ABSTRACT

A method and apparatus for allocating and pricing virtual resources is provided. According to one aspect, pricing information is obtained for a plurality of virtual resources offered by a plurality of providers. A set of selected virtual resources is determined for a first customer. An expected quantity is determined for at least one virtual resource for the first customer. A fixed charge is determined based on the pricing information, the set of selected virtual resources and at least one expected quantity. At least one unit rate is determined for at least one virtual resource based on the pricing information. The first customer is provided access to the set of selected virtual resources during a billing period, wherein the fixed charge is billed for the billing period. An overflow charge, if any, is determined the at least one unit rate and an actual usage during the billing period.

### FIELD OF THE DISCLOSURE

The present disclosure relates to virtual computing. The disclosure relates more specifically to computer-implemented techniques for allocating and pricing virtual resources.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

The usage of cloud computing is increasingly common. Virtual computing resources located at a cloud service provider, who services many unrelated tenants, customers or clients, are delivered as a service over a network, including system platforms, database resources, other software applications, networking resources, storage resources, compute resources, and other computing resources that are virtualized and provided as a service. Numerous cloud services providers are available, such as AMAZON®, WINDOWS AZURE®, RACKSPACE® and many others.

Unlike traditional computing systems, cloud service providers have the capacity to provide customers with practically unbounded resources on demand. However, cloud service providers typically offer a complex array of virtual services and packages that are not easily understood by customers that are accustomed to traditional computing systems. Furthermore, the pricing associated with these services is often complex and unpredictable. A customer has the ability to access unanticipated computing resources on demand, including essential resources necessary for continued operation. However, the customer must also pay an unpredictable cost for the usage of the resources.

### SUMMARY

Techniques, systems, methods and apparatuses are provided for allocating and pricing virtual resources. The claims are hereby incorporated into this summary.

### BRIEF DESCRIPTION OF THE DRAWINGS

In the drawings:

FIG. 1 is a block diagram that illustrates an overview of an embodiment of a system for allocating and pricing virtual resources;

FIG. 2 is a flow diagram that illustrates an embodiment of a method for allocating and pricing virtual resources;

FIG. 3 is a flow diagram that illustrates an embodiment of a method for selecting virtual resources based on one or more parameters;

FIG. 4 is a flow diagram that illustrates an embodiment of a method for implementing a primary account;

FIG. 5 is a flow diagram that illustrates an embodiment of a method for implementing a primary reserve account;

FIG. 6 is a flow diagram that illustrates an embodiment of a method for implementing group accounts;

FIG. 7 illustrates an embodiment of a user interface for displaying account information associated with a customer;

FIG. 8 is a flow diagram that illustrates an embodiment of a method for pricing a dynamic virtual resource assignment;

FIG. 9 is a flow diagram that illustrates an embodiment of a method for allocating and pricing virtual resources for a second customer;

FIG. 10 illustrates a computer system upon which one or more embodiments may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

1. General Overview

Computer-implemented systems and methods are provided for to streamline the selection and pricing of virtual resources. A customer may access virtual resources by specifying traditional performance objectives based on traditional computing systems. The virtual resources may be priced using a predictable model without losing access to the virtual resources because of unanticipated usage. Computer-implemented processes may determine the pricing and compute and provide invoices reflecting the determined pricing. The systems and methods described herein also allow for simplified usage and billing for multiple groups within an organization.

FIG. 1 is a block diagram that illustrates an overview of an embodiment of a system for allocating and pricing virtual resources.

System 100 includes allocation and pricing system 102. Allocation and pricing system 102 is configured to provide at least one customer 122-124 with one or more resources 116-120 offered by providers 112-114. Each of customer 122, 124, allocation and pricing system 102, and provider 112, 114, may be implemented as one or more computers in the form of either a special-purpose computer that is configured as further described herein or a general-purpose computer hosting or executing one or more stored programs which, when executed, perform the functions that are further described herein. Allocation and pricing system 102 communicates with customers 122-124 and providers 112-114 over any combination of one or more networks, such as Local Area Networks (LAN), Wide Area Networks (WAN), wireless networks, optical networks, distributed networks or internetworks, the Internet or any combination thereof. For example, system 102 may include an HTTP server that hosts static web pages or generates dynamic web pages providing a graphical user interface to functions of the system and that delivers pages and receives requests from browsers at customers 122, 124.

Providers 112-114 are configured to provide at least one resource 116-120. In one embodiment, at least one of providers 112-114 is a third-party provider. Allocating and pricing system 102 obtains at least one resource 116-120 as a customer of the third-party provider. In one embodiment, providers 112-114 are cloud service providers configured to provide at least one virtual resource 116-120. Resources 116, 118, 120 may comprise CPUs, storage units, networking resources, and memory or memory units, referenced either in physical terms or as virtual machines or instances.

Allocation and pricing system 102 includes resource assignment module 104, billing module 106, resource allocation module 108 and database 110. Resource assignment module 104, billing module 106, resource allocation module 108 and database 110 may reside in one or more computers. In one embodiment, one or more applications perform the functionality of resource assignment module 104, billing module 106, resource allocation module 108 and database 110. Thus, each of the modules 104, 106, 108 may be implemented as one or more computer programs, other software elements, firmware, other functional logic or any combination thereof in a special-purpose or general-purpose computer. Although a logical module division is provided for clarity to illustrate an example in FIG. 1, the functionality of the modules may be separated and combined differently in other embodiments. Each of the modules and the database 110 may communicate using inter-program communication (IPC) techniques, object method invocations, application programming interface (API) calls, an event bus or other middleware techniques.

Resource assignment module 104 determines a set of resources to provide each customer 122-124 based on pricing information. In one embodiment, the pricing information is stored in database 110. Resource assignment module 104 may determine the set of virtual resources for a customer based on one or more constraints, such as but not limited to one or more performance parameter values and pricing.

Billing module 106 is configured to perform creating and sending invoices and to manage billing records for customers 122-124. Billing module 106 may use a primary account, a primary reserve account, and/or multiple group accounts to track usage for each customer. In one embodiment, billing module 106 determines a fixed charge for an expected usage of the virtual resources by a customer. In one embodiment, the fixed charge is a periodic charge that is billed to a customer every billing period, thereby providing the customer with a predictable billing model when the customer's usage does not exceed the expected usage. Billing module 106 may also determine an overage charge for actual usage that exceeds the expected usage. In one embodiment, billing module 106 may periodically update customer accounts during the billing period to reflect updated usage information during the billing period.

Resource allocation module 108 is configured to provide at least one resource 116-120 to customers 112-124. Each customer 122-124 may be provided a different set of resources 116-120. In one embodiment, resources 116-120 are virtual resources obtained by resource allocation module 108 and provided to customers 122-124.

Database 110 may include pricing information that may be obtained from publicly available information published by one or more cloud service providers. Database 110 may also include unpublished information otherwise disclosed by the providers. In one embodiment, database 110 contains information associating performance parameter values with virtual resources offered by the providers. The pricing information may include information collected based on technical specifications, analytics, testing, correspondence, and other research. Database 110 may be configured to be queried based on one or more performance parameter values. In one embodiment, at least one performance parameter is generic, i.e. applicable to any provider providing the associated resource. In one embodiment, the pricing information is dynamically updated. For example, the pricing information may be updated on a periodic basis, when a new provider is available, when pricing information from the providers changes, when the cost of goods sold changes, when a bulk rate becomes available, or for any other reason.

In one embodiment, allocation and pricing system 102 is configured to provide budgeting, accounting and allocation of resources within an organization. For example, one or more providers 112-114 are configured to provide private cloud instantiations and other cloud resources to client customers 122-124 and/or groups 126-128 within an organization.

2. Allocation and Pricing

FIG. 2 is a flow diagram that illustrates an embodiment of a method for allocating and pricing virtual resources. Such a method may be performed by one or more computing devices. For example, one or more steps of the method may be performed by elements of computer system 1000 (FIG. 10) or computer system 100, such as resource assignment module 104, billing module 106, resource allocation module 108 and FIG. 2 may represent an algorithm that these modules implement individually or in cooperation.

In block 202, pricing information for a plurality of virtual resources offered by a plurality of providers is obtained. The pricing information may be obtained from publicly available information published by one or more cloud service providers, such as providers 112, 114 (FIG. 1); for example, resource assignment module 104 may issue web services requests or HTTP requests to providers 112, 114 using APIs that the providers expose for the purpose of delivering pricing information on demand. The pricing information may also include unpublished information otherwise disclosed by the providers. In one embodiment, the pricing information contains information associating performance parameter values with virtual resources offered by the providers. The pricing information may include information collected based on technical specifications, analytics, testing, correspondence, and other research.

The pricing information may be maintained and stored such that pricing data can be queried based on one or more performance parameter values. Storage in database 110 may be used for this purpose and modules 104, 106, 108 may use a query interface to the interface to send queries and receive result datasets. In one embodiment, at least one performance parameter is generically applicable to any provider providing the associated resource. The pricing information may be queried in based on the generic performance parameters to identify corresponding resources provided by any provider.

A performance parameter value may specify a minimum value, a maximum value, or a range of values. A performance parameter value may also indicate the presence or absence of a particular feature, including but not limited to a type of hardware, hardware acceleration, architecture, and the ability to support an application, service, framework, environment, or other software-based system.

In block 204, a set of selected virtual resources from the plurality of virtual resources for a customer is determined based on the pricing information. The set of selected virtual resources may be further based on one or more constraints, such as one or more performance parameter values. The constraints may also include one or more optimizations. In one embodiment, optimization is based on price. Optimization may also be based on a performance parameter value. For example, the pricing information may be used to determine a set of selected virtual resources with “the fastest CPU speed which satisfies the following parameter values: “at least 30G RAM,” “has Graphics Processing Unit (GPU)” or any other parameter value associated with a virtual resource. When a performance parameter value is used for optimization, a pricing parameter may also be used as a constraint. The set of selected virtual resources may be from a single provider or multiple providers included in the pricing information.

In block 206, an expected quantity for at least one virtual resource in the set of selected virtual resources for the customer is determined. The expected quantity for a virtual resource may be determined based on at least one performance parameter obtained for the customer. For example, an expected quantity might be 1 GB of storage or a particular number of volumes or logical units (LUNs). In one embodiment, the expected quantity is based on at least one usage criteria obtained from the customer. Example usage criteria may reflect minimum read latency, minimum write latency, minimum CPU response time, or other factors. The usage criteria may directly specify a quantity associated with a specific performance parameter value. Determining the expected quantity for the associated virtual resource may involve translating the specified quantity in terms of the specific virtual resource selected.

Alternatively, the usage criteria may include tailored information specific to the customer's business, such as a current or projected database size, user base, traffic, expected growth, expected usage patterns, expected variance in usage, or any other information that may affect usage. In one embodiment, a consultant may work with the customer to define one or more usage criteria and enter the usage criteria in a computationally usable form for determining the expected quantity of at least one virtual resource.

In block 208, a fixed charge is determined based on the pricing information, the set of selected virtual resources and at least one expected quantity associated with the set of selected virtual resources. In one embodiment, the fixed charge is selected to cover the cost of providing the expected quantity of the set of the virtual resources during a billing period. In one embodiment, the fixed charge may be updated based on one or more factors, such as historical usage, a change in a customer's credit, a customer request, a budgeting criteria of a customer, a change in expected usage, a change in a performance parameter or constraint, or for any other factor that may affect the fixed charge.

In block 210, at least one unit rate for at least one virtual resource in the set of selected virtual resources is determined based on the pricing information. In one embodiment, the unit rate applies to usage of a virtual resource that exceeds the expected usage for a specific resource. The unit rate may include one or more formulas or rules usable to calculate the unit rate when the cost of providing a virtual resource is dependent on the usage of one or more other virtual resources.

The unit rates of the set of selected virtual resources may be used to track the customer's usage. In one embodiment, the unit rate is used to track the customer's usage, including usage that is within the expected quantity. The unit rate may include a tiered pricing system for one or more virtual resources that is dependent on the actual amount of usage in excess of the expected amount. For example, one pricing tier may apply for usage within the expected quantity, and while at least one additional pricing applies for usage beyond the expected quantity of a virtual resource. A tiered pricing system may also be used for one or more virtual resources when the cost of obtaining and providing the virtual resource is variable.

In block 212, the customer is provided access to the set of selected virtual resources during a billing period. The customer may be provided access beyond the expected quantity of the set of virtual resources. In block 214, an overflow charge, if any, is determined based on the at least one unit rate and an actual usage of the set of selected virtual resources by the customer during the billing period.

FIG. 3 is a flow diagram that illustrates an embodiment of a method for selecting virtual resources based on one or more parameters. Such a method may be performed by one or more computing devices. For example, one or more steps of the method may be performed by computer system 1000.

In block 302, pricing information for a plurality of virtual resources offered by a plurality of providers is obtained. In block 304, at least one performance parameter for a customer is obtained. In optional block 306, at least one budget parameter for the customer is obtained. In block 308, a set of selected virtual resources from the plurality of virtual resources for a customer is determined based on the at least one performance parameter, and optionally, the at least one budget parameter. In block 310, an expected quantity for at least one virtual resource in the set of selected virtual resources for the customer is determined based on the at least one performance parameter, and optionally, the at least one budget parameter.

3. Primary Accounts and Budgets

FIG. 4 is a flow diagram that illustrates an embodiment of a method for implementing a primary account. Such a method may be performed by one or more computing devices. For example, one or more steps of the method may be performed by computer system 1000.

In block 402, a primary account is generated for a customer. A primary account balance is associated with the primary account. The primary account may be used as a ledger such that the primary account is credited based on payments and debited based on usage. The primary account may be credited for a billing period before or after payment of a fixed charge for the billing period is received. The primary account balance may be negative, allowing a customer's usage to exceed an expected quantity such that the customer can continue to access virtual resources, including virtual resources essential for continued operation.

In block 404, the primary account is credited with a primary budget based on the fixed charge. The primary budget may include credits for a billing period that the customer is entitled to for paying the fixed charge. In one embodiment, the primary account is credited with an amount of currency. Alternatively, the primary account may be credited with points that are not directly equivalent to currency. In one embodiment, the usage of a non-currency credit system is leveraged to implement promotions, tiered pricing, discounts and other marketing or pricing schemes. The primary budget may be credited to the primary account before or after payment for a billing period has been received.

In block 406, the primary account is debited for usage of at least one virtual resource in the set of selected virtual resources during the billing period based on the at least one unit rate. The unit rate may include a tiered pricing system for one or more virtual resources that is dependent on the actual amount of usage in excess of the expected amount. For example, one pricing tier may apply for usage within the expected quantity, and while at least one additional pricing applies for usage beyond the expected quantity of a virtual resource.

In one embodiment, the primary account balance is updated periodically during the billing period to reflect updated usage information during the billing period. For example, if a billing period is one month, the primary account may be debited for usage on a daily basis, an hourly basis, or any other update interval to reflect updated usage information.

In block 408, an overflow charge, if any, is determined based on the primary account balance after the billing period. In one embodiment, an overflow charge is billed when the primary account balance is negative after the billing period. A negative primary account balance may be reset after a bill is generated or collected for the overflow charge. If the primary account balance is positive at the end of the billing period, the primary account balance may be reset to zero for the next billing period. Alternatively, at least a portion of a positive account balance may be carried over to the next billing period.

FIG. 5 is a flow diagram that illustrates an embodiment of a method for implementing a primary reserve account. Such a method may be performed by one or more computing devices. For example, one or more steps of the method may be performed by computer system 1000.

In block 502, a primary reserve account is generated for a customer. In one embodiment, a primary reserve account is accessed when a primary account balance is negative. The primary reserve account may be accessed at the end of a billing period. In one embodiment, the primary reserve account is accessed during a billing period after the credits in the primary account are consumed.

In block 504, the primary reserve account is credited. In one embodiment, the primary reserve account is credited based on a reserve amount paid by the customer. The reserve amount may be an optional or mandatory charge billed to the customer. The reserve amount may also be based on an optional reserve amount determined by the customer. In one embodiment, the primary reserve account is credited with an amount of currency. Alternatively, the primary account may be credited with points that are not directly equivalent to currency. In one embodiment, the usage of a non-currency credit system is leveraged to implement promotions, tiered pricing, discounts and other marketing or pricing schemes.

In block 506, an overflow charge, if any, is determined. In addition to the other factors described herein, the overflow charge may be further based on the primary reserve account balance. In one embodiment, the unit rate for usage over the expected quantity is less when the primary reserve account contains sufficient credit to cover the usage.

4. Group Accounts and Budgets

Group accounts are sub-accounts that are associated with the primary account of a customer. A thin provisioning billing model may be used to allow group budgets to exceed a primary budget. In one embodiment, a primary reserve account is used to determine how much the group budgets may exceed the primary budget. FIG. 6 is a flow diagram that illustrates an embodiment of a method for implementing group accounts. Such a method may be performed by one or more computing devices. For example, one or more steps of the method may be performed by computer system 1000.

In block 602, a plurality of group accounts is generated for the customer. Each group account corresponds to a group authorized to use the set of selected virtual resources associated with the customer. Group accounts may relate to one or more departments, teams, goals, objectives, or any other administrative or logical division of the customer. In one embodiment, the plurality of group accounts is generated by an administrator associated with the customer. For example, an administrator may be authorized to view, create, delete and/or modify one or more group accounts and/or group budgets, such as via user interface 700.

One or more users associated with the customer are assigned to the group accounts. In one embodiment, a user may be associated with more than one group account. A user authorized to use multiple group accounts may be authenticated to use one of the multiple group accounts when using virtual resources so that the use is charged to the applicable group account. In one embodiment, a user may choose to charge usage against multiple group accounts and the charge is divided between the multiple group accounts.

In block 604, a plurality of group budgets is obtained. The sum of the plurality of group budgets may be greater than the primary budget. In one embodiment, the sum of the plurality of group budgets is greater than the primary budget but less than or equal to the sum of the primary budget and a primary reserve account balance. Additionally or alternatively, the primary budget may be thin provisioned such that its value is less than the sum of balances in all the group budgets, effectively allowing the customer to budget more than the total funds that it has actually paid, contributed or committed to the primary budget. In one embodiment, the primary reserve account contains actual credits based on an actual amount paid by a customer. Additionally or alternatively, the primary reserve account acts as an accounting tool to determine how much the customer's total actual usage can exceed the primary budget.

The group budgets allow the customer to budget based on an anticipated usage by multiple entities belonging to the customer that may require access to the customer's set of virtual resources. For example, group budgets may be assigned to departments, teams or other divisions of the customer. Group budgets may also be assigned based on goals or objectives, where a group budget relates to the projected amount of resources for completing the goal or objective.

In one embodiment, an administrator associated with the customer may view the customer's historical usage by group to aid in budgeting. The customer may be allowed to add funds to the primary reserve account and/or the primary account. In one embodiment, the customer is allowed to request an increase in the fixed charge, thereby increasing a primary budget that is be credited to the primary account. The customer's fixed charge for each billing period may also be increased based on new performance parameter values supplied by the customer and/or historical usage data of the customer.

In block 606, both the primary account and an associated group account are debited for usage of at least one virtual resource in the set of selected virtual resources. The primary account balance and the group account balances may be updated periodically during the billing period to reflect updated usage information during the billing period. In a preferred embodiment, the customer is billed based on the primary account balance at the end of the billing period. Alternatively, individual group account information may be used to determine a charge for the customer, such as the overage charge. In one embodiment, group account balances may be provided to the customer for its internal use.

FIG. 7 illustrates an embodiment of a user interface for displaying account information associated with a customer. User interface 700 includes account information for customer 702, including primary account balance 704, primary reserve account balance 706 and fixed charge 708. Fixed charge 708 covers an expected usage of virtual resources by customer 702 during a billing period. User interface may also display remaining period 710 of the billing period. As shown in user interface 700, primary account balance 704 and primary reserve account balance 706 reflect balances at the beginning of the billing cycle before the deduction of group usage sum 718.

User interface 700 also includes group account information 716 for a plurality of group accounts, such as group account budgets 712 and usage information 714, group budgets sum 716 and group usage sum 718. Usage information 714 reflects an amount to be debited for actual usage of virtual resources by each group during the current billing period. Warning 720 is shown when an individual group budget is exceeded by the group. In one embodiment, when the group budget is exceeded by a group but the total usage by all groups remains below the expected usage, no overage charge is billed. Warnings may also be implemented for other conditions, such as when group usage sum 718 exceeds or is close to exceeding primary account balance 704.

Group usage sum 718 reflects an amount to be debited for the total usage of virtual resources by customer 702. The sum of the group account budgets 716 is allowed to exceed primary account balance 704 but is less than the sum of primary account balance 704 and primary reserve account balance 706.

User interface 700 includes user interface elements 722-732 that allow an administrator associated with customer 702 to manage the group account. User interface elements 722-728 enable an administrator to modify individual group account information, including the group account budget. User interface element 730 allows the administrator to add or remove a group. User interface element 732 allows the administrator to manage the primary account.

5. Resource Assignment

FIG. 8 is a flow diagram that illustrates an embodiment of a method for pricing a dynamic virtual resource assignment. Such a method may be performed by one or more computing devices. For example, one or more steps of the method may be performed by computer system 1000.

In block 802, at least one virtual resource assigned to the set of selected virtual resources associated with the customer is changed during a billing period. For example, the set of virtual resources may be dynamically selected to optimize for one or more factors, such as pricing information and one or more performance parameter values. A change in the virtual resources may result in a pricing change for the customer. For example, a unit rate for any changed virtual resources may be increased or decreased based on the pricing information obtained for the changed virtual resources. Alternatively, pricing may be kept constant for the customer. For example, pricing may be kept constant to increase an offset or margin, to provide a predictable billing scheme, or for any other purpose.

In block 804, an overflow charge, if any, is determined. In addition to the other factors described herein, the overflow charge may be further based on the change to the set of selected virtual resources. In one embodiment, the unit rate for one or more virtual resources is changed based on the change to the set of selected virtual resources, leading to a change in any overflow charge determined for the customer.

FIG. 9 is a flow diagram that illustrates an embodiment of a method for allocating and pricing virtual resources for an additional customer. Such a method may be performed by one or more computing devices. For example, one or more steps of the method may be performed by computer system 1000.

In block 902, a second expected quantity is determined for at least one virtual resource in a second set of selected virtual resources for a second customer. In block 904, a second fixed charge is determined based on the pricing information, the second set of selected virtual resources and at least one second expected quantity associated with the second set of selected virtual resources. In block 906, at least one second unit rate is determined for at least one virtual resource in the second set of selected virtual resources based on the pricing information. In block 908, the second customer is provided access to the second set of selected virtual resources.

In block 910, access to common virtual resources is obtained. The common virtual resources include virtual resources that are in both the first set of selected virtual resources and the second set of virtual resources. The common virtual resources include at least one virtual resource that is made available to both the first customer and the second customer.

In block 912, virtual resources in the common virtual resources are allocated to the first customer and the second customer. In one embodiment, a common virtual resource is dynamically allocated between the first customer and the second customer. When a common virtual resource is allocated between a first customer and a second customer, it may result in a pricing change for the customer. For example, a unit rate for any changed virtual resources may be increased or decreased based on the pricing information obtained for the common virtual resource. Alternatively, pricing may be kept constant for the customer. For example, pricing may be kept constant to increase an offset or margin, to provide a predictable billing scheme, or for any other purpose.

6. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

For example, FIG. 10 illustrates a computer system upon which one or more embodiments may be implemented. Computer system 1000 includes a bus 1002 or other communication mechanism for communicating information, and a hardware processor 1004 coupled with bus 1002 for processing information. Hardware processor 1004 may be, for example, a general purpose microprocessor.

Computer system 1000 also includes a main memory 1006, such as a random access memory (RAM) or other dynamic storage device, coupled to bus 1002 for storing information and instructions to be executed by processor 1004. Main memory 1006 also may be used for storing temporary variables or other intermediate information during execution of instructions to be executed by processor 1004. Such instructions, when stored in non-transitory storage media accessible to processor 1004, render computer system 1000 into a special-purpose machine that is customized to perform the operations specified in the instructions.

Computer system 1000 further includes a read only memory (ROM) 1008 or other static storage device coupled to bus 1002 for storing static information and instructions for processor 1004. A storage device 1010, such as a magnetic disk, optical disk, or solid-state drive is provided and coupled to bus 1002 for storing information and instructions.

Computer system 1000 may be coupled via bus 1002 to a display 1012, such as a cathode ray tube (CRT), for displaying information to a computer user. An input device 1014, including alphanumeric and other keys, is coupled to bus 1002 for communicating information and command selections to processor 1004. Another type of user input device is cursor control 1016, such as a mouse, a trackball, or cursor direction keys for communicating direction information and command selections to processor 1004 and for controlling cursor movement on display 1012. This input device typically has two degrees of freedom in two axes, a first axis (e.g., x) and a second axis (e.g., y), that allows the device to specify positions in a plane.

Computer system 1000 may implement the techniques described herein using customized hard-wired logic, one or more ASICs or FPGAs, firmware and/or program logic which in combination with the computer system causes or programs computer system 1000 to be a special-purpose machine. According to one embodiment, the techniques herein are performed by computer system 1000 in response to processor 1004 executing one or more sequences of one or more instructions contained in main memory 1006. Such instructions may be read into main memory 1006 from another storage medium, such as storage device 1010. Execution of the sequences of instructions contained in main memory 1006 causes processor 1004 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 1010. Volatile media includes dynamic memory, such as main memory 1006. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1002. Transmission media can also take the form of acoustic or light waves, such as those generated during radio-wave and infra-red data communications.

Various forms of media may be involved in carrying one or more sequences of one or more instructions to processor 1004 for execution. For example, the instructions may initially be carried on a magnetic disk or solid-state drive of a remote computer. The remote computer can load the instructions into its dynamic memory and send the instructions over a telephone line using a modem. A modem local to computer system 1000 can receive the data on the telephone line and use an infra-red transmitter to convert the data to an infra-red signal. An infra-red detector can receive the data carried in the infra-red signal and appropriate circuitry can place the data on bus 1002. Bus 1002 carries the data to main memory 1006, from which processor 1004 retrieves and executes the instructions. The instructions received by main memory 1006 may optionally be stored on storage device 1010 either before or after execution by processor 1004.

Computer system 1000 also includes a communication interface 1018 coupled to bus 1002. Communication interface 1018 provides a two-way data communication coupling to a network link 1020 that is connected to a local network 1022. For example, communication interface 1018 may be an integrated services digital network (ISDN) card, cable modem, satellite modem, or a modem to provide a data communication connection to a corresponding type of telephone line. As another example, communication interface 1018 may be a local area network (LAN) card to provide a data communication connection to a compatible LAN. Wireless links may also be implemented. In any such implementation, communication interface 1018 sends and receives electrical, electromagnetic or optical signals that carry digital data streams representing various types of information.

Network link 1020 typically provides data communication through one or more networks to other data devices. For example, network link 1020 may provide a connection through local network 1022 to a host computer 1024 or to data equipment operated by an Internet Service Provider (ISP) 1026. ISP 1026 in turn provides data communication services through the world wide packet data communication network now commonly referred to as the “Internet” 1028. Local network 1022 and Internet 1028 both use electrical, electromagnetic or optical signals that carry digital data streams. The signals through the various networks and the signals on network link 1020 and through communication interface 1018, which carry the digital data to and from computer system 1000, are example forms of transmission media.

Computer system 1000 can send messages and receive data, including program code, through the network(s), network link 1020 and communication interface 1018. In the Internet example, a server 1030 might transmit a requested code for an application program through Internet 1028, ISP 1026, local network 1022 and communication interface 1018.

The received code may be executed by processor 1004 as it is received, and/or stored in storage device 1010, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
obtaining pricing information for a plurality of virtual resources offered by a plurality of providers;
determining a set of selected virtual resources from the plurality of virtual resources for a first customer;
determining an expected quantity for a billing period for at least one virtual resource in the set of selected virtual resources for the first customer;
determining a fixed charge based on the pricing information, the set of selected virtual resources and at least one expected quantity associated with the set of selected virtual resources, wherein the first customer is billed the fixed charge for the billing period;
determining at least one unit rate for at least one virtual resource in the set of selected virtual resources based on the pricing information;
providing the first customer access to the set of selected virtual resources during the billing period;
determining an overflow charge, if any, based on the at least one unit rate and an actual usage of the set of selected virtual resources by the first customer during the billing period;
wherein the method is performed by one or more computing devices.

2. The method of claim 1, further comprising:
obtaining at least one performance parameter for a first customer;
wherein determining the set of selected virtual resources is based on the at least one performance parameter;
wherein determining the expected quantity is based on the at least one performance parameter.

3. The method of claim 2, wherein the pricing information comprises a database, wherein the database is dynamically updated with updated pricing information.

4. The method of claim 2, wherein the pricing information comprises a database associating at least one performance parameter value with the plurality of virtual resources offered by the plurality of providers.

5. The method of claim 1, further comprising:
generating a primary account for the first customer, wherein a primary account balance associated with the primary account may be negative;
crediting the primary account with a primary budget based on the fixed charge;
charging the primary account for usage of at least one virtual resource in the set of selected virtual resources during the billing period based on the at least one unit rate;
wherein the overflow charge, if any, is further determined based on the primary account balance after the billing period.

6. The method of claim 5, further comprising:
generating a plurality of group accounts for the first customer, wherein each group account corresponds to a group authorized to use the set of selected virtual resources associated with the first customer;
obtaining a plurality of group budgets, wherein the sum of the plurality of group budgets is greater than the primary budget;
wherein usage of at least one virtual resource in the set of selected virtual resources is debited from both the primary account and an associated group account even when one of the primary account and the associated group account is negative.

7. The method of claim 5, further comprising:
generating a primary reserve account for the first customer;
crediting the primary reserve account;
wherein the overflow charge, if any, is further determined based on the primary reserve account balance.

8. The method of claim 7, further comprising:
generating a plurality of group accounts for the first customer, wherein each group account corresponds to a group authorized to use the set of selected virtual resources associated with the first customer;
obtaining a plurality of group budgets, wherein the sum of the plurality of group budgets is greater than the primary budget and less than or equal to the sum of the primary budget and a primary reserve account balance;
wherein usage of at least one virtual resource in the set of selected virtual resources is debited from both the primary account and an associated group account even when one of the primary account and the associated group account is negative.

9. The method of claim 8, further comprising:
providing a user interface configured to display information associated with the primary account, the primary reserve account, and the plurality of group accounts to an authorized user associated with the first customer;
wherein the user interface is further configured to allow the authorized user to modify at least one of the plurality of group budgets.

10. The method of claim 9, wherein the user interface is further configured to allow the authorized user to create or remove at least one group.

11. The method of claim 1, further comprising obtaining at least one budget parameter for the first customer, wherein the set of selected virtual resources is further determined based on the at least one budget parameter.

12. The method of claim 1, further comprising:
changing at least one virtual resource assigned to the set of selected virtual resources associated with the first customer during the billing period;
wherein determining an overflow charge, if any, is further based on the change to the set of selected virtual resources.

13. The method of claim 1, further comprising:
determining a second expected quantity for at least one virtual resource in a second set of selected virtual resources for a second customer;
determining a second fixed charge based on the pricing information, the second set of selected virtual resources and at least one second expected quantity associated with the second set of selected virtual resources;
determining at least one second unit rate for at least one virtual resource in the second set of selected virtual resources based on the pricing information;
providing the second customer access to the second set of selected virtual resources;
obtaining access to at least one common virtual resource in both the first set of selected virtual resources and the second set of virtual resources;
providing the first customer and the second customer access comprises allocating the at least one common virtual resource to the first customer and the second customer.

14. A computer-readable medium carrying one or more sequences of instructions for allocating and pricing virtual resources, which instructions, when executed by one or more processors, cause one or more processors to carry out the steps of:
obtaining pricing information for a plurality of virtual resources offered by a plurality of providers;
determining a set of selected virtual resources for the first customer from the plurality of virtual resources;
determining an expected quantity for at least one virtual resource in the set of selected virtual resources for the first customer;
determining a fixed charge based on the pricing information, the set of selected virtual resources and at least one expected quantity associated with the set of selected virtual resources;
determining at least one unit rate for at least one virtual resource in the set of selected virtual resources based on the pricing information;
providing the first customer access to the set of selected virtual resources during a billing period, wherein the fixed charge is billed for the billing period;
determining an overflow charge, if any, based on the at least one unit rate and an actual usage of the set of selected virtual resources by the first customer during the billing period;
wherein the method is performed by one or more computing devices.

15. The computer-readable medium of claim 14, further comprising instructions which, when executed by the one or more processors, cause the one or more processors to perform:
obtaining at least one performance parameter for a first customer;
wherein determining the set of selected virtual resources is based on the at least one performance parameter;
wherein determining the expected quantity is based on the at least one performance parameter.

16. The computer-readable medium of claim 15, wherein the pricing information comprises a database, wherein the database is dynamically updated with updated pricing information.

17. The computer-readable medium of claim 15, wherein the pricing information comprises a database associating at least one performance parameter value with the plurality of virtual resources offered by the plurality of providers.

18. The computer-readable medium of claim 14, further comprising instructions which, when executed by the one or more processors, cause the one or more processors to perform:
generating a primary account for the first customer, wherein a primary account balance associated with the primary account may be negative;
crediting the primary account with a primary budget based on the fixed charge;
charging the primary account for usage of at least one virtual resource in the set of selected virtual resources during the billing period based on the at least one unit rate;
wherein the overflow charge, if any, is further determined based on the primary account balance after the billing period.

19. The method of claim 18, further comprising:
generating a plurality of group accounts for the first customer, wherein each group account corresponds to a group authorized to use the set of selected virtual resources associated with the first customer;
obtaining a plurality of group budgets, wherein the sum of the plurality of group budgets is greater than the primary budget;
wherein usage of at least one virtual resource in the set of selected virtual resources is debited from both the primary account and an associated group account even when one of the primary account and the associated group account is negative.

20. The computer-readable medium of claim 18, further comprising instructions which, when executed by the one or more processors, cause the one or more processors to perform:
generating a primary reserve account for the first customer;
crediting the primary reserve account;
wherein the overflow charge, if any, is further determined based on the primary reserve account balance.

21. The computer-readable medium of claim 20, further comprising instructions which, when executed by the one or more processors, cause the one or more processors to perform:
generating a plurality of group accounts for the first customer, wherein each group account corresponds to a group authorized to use the set of selected virtual resources associated with the first customer;
obtaining a plurality of group budgets, wherein the sum of the plurality of group budgets is greater than the primary budget and less than or equal to the sum of the primary budget and a primary reserve account balance;
wherein usage of at least one virtual resource in the set of selected virtual resources is debited from both the primary account and an associated group account even when one of the primary account and the associated group account is negative.

22. The computer-readable medium of claim 21, further comprising instructions which, when executed by the one or more processors, cause the one or more processors to perform:
providing a user interface configured to display information associated with the primary account, the primary reserve account, and the plurality of group accounts the to an authorized user associated with the first customer;
wherein the user interface is further configured to allow the authorized user to modify at least one of the plurality of group budgets.

23. The computer-readable medium of claim 22, wherein the user interface is further configured to allow the authorized user to create or remove at least one group.

24. The computer-readable medium of claim 14, further comprising instructions which, when executed by the one or more processors, cause the one or more processors to perform:
obtaining at least one budget parameter for the first customer, wherein the set of selected virtual resources is further determined based on the at least one budget parameter.

25. The computer-readable medium of claim 14, further comprising instructions which, when executed by the one or more processors, cause the one or more processors to perform:
changing at least one virtual resource assigned to the set of selected virtual resources associated with the first customer during the billing period;
wherein determining an overflow charge, if any, is further based on the change to the set of selected virtual resources.

26. The computer-readable medium of claim 14, further comprising instructions which, when executed by the one or more processors, cause the one or more processors to perform:
determining a second expected quantity for at least one virtual resource in a second set of selected virtual resources for a second customer;
determining a second fixed charge based on the pricing information, the second set of selected virtual resources and at least one second expected quantity associated with the second set of selected virtual resources;
determining at least one second unit rate for at least one virtual resource in the second set of selected virtual resources based on the pricing information;
providing the second customer access to the second set of selected virtual resources;
obtaining access to at least one common virtual resource in both the first set of selected virtual resources and the second set of virtual resources;
providing the first customer and the second customer access comprises allocating the at least one common virtual resource to the first customer and the second customer.
